(19) United States
(12) Patent Application Publication
(10) Pub. No.: US 2003/0055625 A1
(43) Pub. Date: Mar. 20, 2003

(54) Linguistic assistant for domain analysis methodology

(76) Inventors: Tatiana Korelsky, Ithaca, NY (US); Benoit Lavoie, Ithaca, NY (US); Owen Rambow, Hoboken, NJ (US); Richard Kittredge, Ithaca, NY (US)

Correspondence Address: BROWN & MICHAELS, PC, 400 M & T BANK BUILDING, 118 NORTH TIOGA ST, ITHACA, NY, 14850, US

(21) Appl. No.: 09/870,948

(22) Filed: May 31, 2001

(51) Int. Cl. G06F 17/27

(52) U.S. Cl. 704/9

(57) ABSTRACT

A Linguistic Assistant For Domain Analysis Methodology to help a user define object models from documents such as requirements documents and validate object models against such documents. The approach is domain-independent and language-independent, mainly relying on widely available linguistic resources for the text analysis.

### ACKNOWLEDGMENT OF GOVERNMENT SUPPORT

This information was made with Government Support under Contract F30602-98-C-0278 awarded by the Air Force. The Government has certain rights in this invention.

### BACKGROUND OF THE INVENTION

1. Field of the Invention

The invention pertains to the field of methods for conceptual modeling assisted by linguistic processing. More particularly, the invention pertains to a methodology which guides a user in iteratively deriving object models from textual documents such as requirements documents and validating such object models against the documents.

2. Description of Related Art

We are aware of three other methodologies that offer some similarities with the present invention, but these methodologies also offer important differences with the present invention. Two of these methodologies result from academic research projects and are described in academic publications; one results from a commercial project.

The Natural Language Analysis methodology (Chen,1983), resulting from academic research, was introduced as a way to produce entity-relationship models from text using general heuristics including the following: i) associate common nouns appearing in sentences with entities; ii) associate transitive verbs appearing in sentences with actions; iii) associate adjectives appearing in sentences with attributes. The present invention offers the following similarities with the Natural Language Analysis methodology:

i) Like the Natural Language Analysis methodology, the present invention relies on automatic part-of-speech tagging to help identify the grammatical roles of words in requirements documents in preparation for a user's identification of the model elements.

However, the present invention also offers several distinctions with the Natural Language Analysis methodology:

i) Unlike the Natural Language Analysis methodology, the present invention handles complete documents and not just individual sentences;

ii) Unlike the Natural Language Analysis methodology, the present invention uses a display of word frequencies to help the user identify the most significant model element candidates;

iii) Unlike the Natural Language Analysis methodology, the present invention relies intensively on a concordance display of word context information in order to help the user determine the relevant dependencies between the model elements;

iv) Unlike the Natural Language Analysis methodology, the present invention is not limited to Entity-Relationship models, but can be used with models in Unified Modeling Language (UML), or any similar modeling language;

v) Unlike the Natural Language Analysis methodology, the present invention enables the validation of models through text analysis;

vi) Unlike the Natural Language Analysis methodology, the present invention enables the validation of models through text generation (synthesis of text from models).

The KISS methodology (Hoppenbrouwers et al., 1996) is offered by the Dutch consulting group KISS Solutions b.v. (http://www.kiss.nl). The first step of the KISS methodology, implemented in a KISS tool called Grammalizer, consists in the part-of-speech tagging and grammatical analysis of text fragments in a requirements document that a user considers relevant for modeling. Grammalizer's analysis results in a list of structured sentences annotated with KISS concepts that the user verifies manually in order to eliminate from the structured sentences the information that is not relevant for modeling. The remaining structured sentences are then used for code generation, including the automatic creation of a model diagram corresponding to the structured sentences. The present invention offers the following similarities with the KISS methodology:

i) As in the KISS methodology, the present invention allows starting from a requirements document in order to produce a new object model;

ii) As in the KISS methodology, the present invention also relies on the part-of-speech tagging of documents;

iii) As in the KISS methodology, the present invention enables the validation of models through text generation.

However, the present invention also offers several distinctions with the KISS methodology:

i) Unlike the KISS methodology, the present invention covers the case in which a modeler starts from an existing object model in order to validate it or refine it using a document. In particular, the KISS methodology does not provide any support for validating an existing model or refining a model already created from structured sentences using text analysis; the KISS methodology is unidirectional, starting from the text analysis process to the generation of an object model. By comparison, the present innovation enables the user to go back and forth between the text analysis process, the modeling process and the validation process;

ii) Unlike the KISS methodology, the present invention is not based on automatic extraction of model element candidates but offers the user general guidelines to help him/her identify the model elements and their relationships;

iii) Unlike the KISS methodology, the present invention depends on no lexical and grammatical resources comparable to those required for the KISS methodology. The KISS methodology requires hand-tailored grammatical structures to extract structured sentences and manually prepared domain-specific lexicons to map the sentence words to KISS concepts. These customized resources are not readily available for new domains or new languages and are time-consuming to develop. The present invention relies mainly on the lexical and grammatical resources already included in part-of-speech taggers (and which are widely available for several languages). The present invention also relies on a small list of “stop words” and heuristics in order to filter from the documents words that are not relevant for domain modeling;

iv) Unlike the KISS methodology, which relies on KISS-specific structured sentences annotated with KISS concepts, the present invention uses standard object-oriented terminology (e.g., Unified Modeling Language) for representing model element candidates, making the present invention immediately usable with a wide range of CASE tools;

v) Unlike the KISS methodology, the present invention relies intensively on a concordance display of word context information in order to help the user determine the relevant dependencies between the model elements.

The COLOR-X methodology (Burg and van de Riet, 1996) is the result of an academic research project. The COLOR-X methodology reuses some of the ideas of the KISS methodology and is implemented partially in the COLOR-X CASE Environment prototype. Like the KISS methodology, the COLOR-X methodology starts from the part-of-speech tagging and grammatical analysis of text fragments contained in requirements documents that the user has selected on the basis of their relevance for modeling. (Note that grammatical analysis has not yet been implemented in the COLOR-X CASE Environment prototype). The result of the part-of-speech tagging and grammatical analysis produces structured sentences similar to KISS structured sentences. The COLOR-X methodology then offers the user a semantic lexicon such as WordNet (Miller et al., 1990) to support manual annotation of the structured sentences with semantic information, making their meanings more explicit and identifying the semantic relationships between sentence elements. The resulting structured sentences, annotated with semantic information, are represented in a specification language called Conceptual Prototyping Language (CPL) that can be reused during all the remaining phases of the development process, including the generation of a model diagram from CPL. The present invention offers the following similarities with the COLOR-X methodology:

i) As in the COLOR-X methodology, the present invention covers the case in which a modeler starts from a document in order to produce a new object model;

ii) As in the COLOR-X methodology, the present invention enables an iterative process between the text analysis phase and the validation of the resulting object model;

iii) As in the COLOR-X methodology, the present invention also relies on the part-of-speech tagging of documents;

iv) As in the COLOR-X methodology, the present invention enables the validation of models through text generation.

However, the present invention also offers several distinctions with the COLOR-X methodology:

i) Unlike the COLOR-X methodology, the present invention is not based on automatic extraction of model element candidates resulting from grammatical analysis but offers the user general guidelines helping him/her to identify the model elements and their relationships;

ii) Unlike the COLOR-X methodology, the present invention depends on no lexical, grammatical and semantic resources comparable to those used in the COLOR-X methodology. The COLOR-X methodology requires hand-tailored grammatical patterns to extract structured sentences as well as a semantic lexicon. However, these resources are not readily available for new domains or new languages and are time-consuming to develop. The present invention relies mainly on the lexical and grammatical resources already included in the part-of-speech taggers, which are widely available for several languages. The present invention also relies on a small list of stop words and heuristics in order to filter from the documents those words that are not relevant for modeling;

iii) Unlike the COLOR-X methodology, the present invention relies entirely on standard concepts and standard notations for representing the model element candidates; while the COLOR-X methodology relies on its specific and complex modeling language, CPL, the current invention can use UML for its concepts and notation, making the present invention immediately usable with a wide range of CASE tools;

iv) Unlike the KISS methodology, the present invention relies intensively on a concordance display of word context information in order to help the user determine the relevant dependencies between the model elements.

### SUMMARY OF THE INVENTION

The Linguistic Assistant For Domain Analysis (LIDA) Methodology guides a user in iteratively deriving models in an object-oriented modeling language from documents such as requirements documents and validating such object models against the documents. The methodology uses automatic linguistic processing to analyze documents and to paraphrase models in a natural language such as English, and was reduced to practice in a software tool, also called LIDA.

The automatic linguistic processing used in LIDA is domain-independent and may be carried out in any one of a variety of languages, relying only on widely available linguistic resources for the language of interest. This processing is performed by three components: the Document Analysis component, the Document-Model Comparison component, and the Model Paraphrase component. LIDA also includes a Text Analysis Environment where the user identifies candidate model elements using the Document Analysis component, and a Model Description Environment where the user develops, records, and validates object models, using the Document-Model Comparison and Model Paraphrase components.

The LIDA Methodology can be applied to any object-oriented modeling language that distinguishes classes (or entities), as well as associations between the classes (or relationships between the entities). Since object-oriented models can be seen as a generalization of Entity-Relation (E-R) models, the Methodology applies equally well to E-R models. The specific object-oriented modeling language UML (Unified Modeling Language) was chosen for the LIDA tool because of UML's wide acceptance.

The LIDA Methodology of iteratively deriving object models from documents includes the following three phases: the Model Element Identification phase, the Model Element Association phase, and the Model Validation phase. These phases can be iterated and interleaved. In particular, the user can either derive a new model from a document, or validate an existing model against a document and refine this model.

### BRIEF DESCRIPTION OF THE DRAWINGS

FIG. 1 shows a diagram of data flow between components of the LIDA tool.

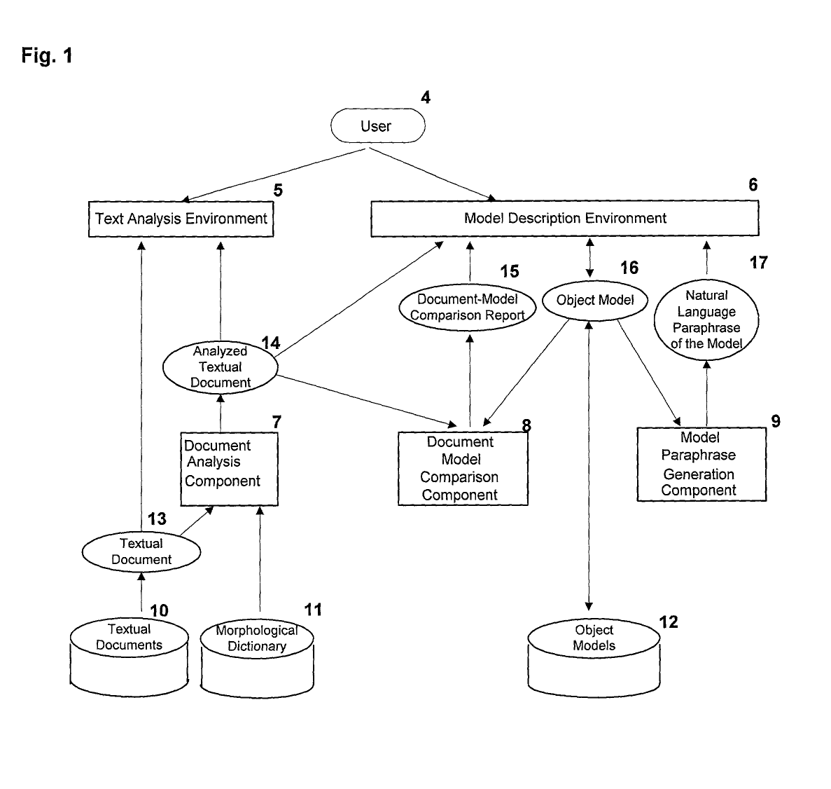

FIG. 2 shows a flowchart of the three phases of the LIDA Methodology.

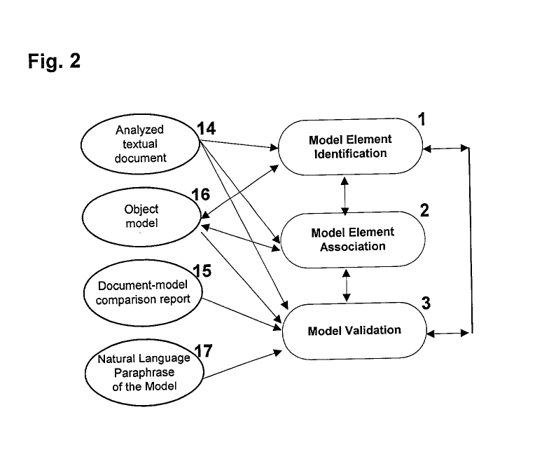

FIG. 3 shows a flowchart of the Model Element Identification phase of the LIDA Methodology.

FIG. 4 shows a flowchart of the Model Element Association phase of the LIDA Methodology.

FIG. 5 shows a flowchart of the Model Validation phase of the LIDA Methodology.

FIG. 6 shows a sample screen shot of the Text Analysis Environment.

FIG. 7 shows a sample screen shot of the Model Description Environment

FIG. 8 illustrates a description of the classes student and course based on the model shown in FIG. 7.

### DETAILED DESCRIPTION OF THE INVENTION

As indicated above, the LIDA Methodology can be applied to any object-oriented modeling language that distinguishes classes (or entities), as well as associations between the classes (or relationships between the entities). The LIDA Methodology was reduced to practice in the LIDA tool using UML. The following detailed description of the invention is thus presented in UML terminology.

The invention uses five main components:

The Document Analysis component identifies word base forms and noun phrases contained in a document; determines their parts of speech and frequencies; records collocations between pairs of word base forms and frequencies of these collocations, and identifies all textual contexts of a particular word base form or noun phrase in a document. This information is stored in a structure called Analyzed Textual Document that is used by the other components.

The Document-Model Comparison component automatically compares labels of model elements with word base forms and noun phrases in an Analyzed Textual Document, taking into account their frequencies, and generates warnings if there are certain discrepancies.

The Model Paraphrase component automatically creates descriptions of models in natural language from the representation of models in UML.

The Text Analysis Environment supports the user in the identification of the candidate model elements via a convenient graphical interface.

The Model Description Environment supports the user during model creation, evolution and validation via a convenient graphical interface.

The LIDA Methodology of iteratively deriving object models from documents includes the following three phases:

In the Model Element Identification phase, the user works within the Text Analysis Environment. The user identifies the model elements candidates (classes, attributes and roles in associations) using linguistic information contained in the Analyzed Textual Document (word base forms, noun phrases, collocations, word frequencies, and textual contexts) produced by the Document Analysis component. The identified model element candidates are automatically recorded by the Model Description Environment.

In the Model Association phase the user works within the Model Description Environment and defines relationships between model element candidates, i.e. declares associations between classes and assigns attributes to classes. In doing so, the user takes into account the textual contexts of word base forms and noun phrases and their collocations in these contexts, relying on information which is contained in the Analyzed Textual Document. The defined associations are recorded by the Model Description Environment.

In the Model Validation phase the user validates a particular model against a particular document, using the Document-Model Comparison component, as well as the Model Paraphrase component.

The text below first describes the components of the LIDA tool in more detail. This is followed by a detailed description of the three phases of the LIDA Methodology, which use the output of the linguistic processing components of the LIDA tool and are supported by its Model Description Environment.

### I. The Components and Environments of the LIDA Tool

1. Document Analysis Component.

The input to the Document Analysis component (7) consists of a document such as a requirements document (13).

The output of the Document Analysis component (7) is an Analyzed TextualDocument (13) consisting of (i) lists of the word base forms and noun phrases contained in a document; (ii) part of speech and frequency for each listed word form or phrase; (iii) collocations between pairs of word base forms and frequencies of these collocations; and (iv) all textual contexts of a particular word base form or noun phrase in a document.

To illustrate how the Document Analysis component (7) works, let us consider the following extract from a Document (13):

TABLE 1
There are two types of people here, employees and
students. All employees have a base salary and an ID
number. The major group of employees is professors.
They have a tenure status - yes or no. Professors
teach courses, which students take. Courses have a
number and a name and a maximum enrollment. Each
course is taught by one professor, sometimes two.
Students must take at least one course, and each
professor teaches exactly one course.

The Document Analysis component (7) begins with the morphological analysis of each sentence of the document in order to determine the part of speech and the base form of each word contained in the sentence. With each sentence is associated the list of word base form/part-of-speech pair it contains, excluding stop words that are considered irrelevant for the identification of model elements. The stop words include articles, prepositions, pronouns, conjunctions, punctuation marks, adverbs, and the two verbs be and have. As a result of this processing, a list of stemmed sentences is produced, which is the list of sentences contained in the document with their associated list of stemmed nouns, verbs and adjectives. Table 2 shows the resulting list of stemmed sentences for the document extract in Table 1.

TABLE 2

| Sentence | |
|---|---|
| no | Sentence/Word base forms for nouns, verbs and adjectives |
| 1 | There are two types of people here, employees |
| | and students. |
| | type [noun] person [noun] employee [noun] |
| | student [noun] |
| 2 | All employees have a base salary and an ID |
| | number. |
| | employee [noun] base [noun] salary [noun] ID |
| | [noun] number [noun] |
| 3 | The major group of employees is professors. |
| | major [adjective] group [noun] employee [noun] |
| | professor [noun] |
| 4 | They have a tenure status - yes or no. |
| | tenure [noun] status [noun] |
| 5 | Professors teach courses, which students take. |
| | professor [noun] teach [verb] course [noun] |
| | student [noun] take [verb] |
| 6 | Courses have a number and a name and a maximum |
| | enrollment. |
| | course [noun] number [noun] name [noun] maximum |
| | [adjective] enrollment [noun] |
| 7 | Each course is taught by one professor, |
| | sometimes two. |
| | course [noun] teach [verb] professor [noun] |
| 8 | Students must take at least one course, and each |
| | professor teaches exactly one course. |
| | student [noun] take [verb] course [noun] |
| | professor [noun] teach [verb] course [noun] |

Further, the Document Analysis component (7) creates a list of the word base form/part-of-speech pairs and a list of all noun phrases contained in the document. It associates with each item on these lists the following information:

(i) the number of occurrences of the item in the document;

(ii) a list of all sentences containing occurrences of the item in the document;

(iii) the noun, verb, and adjective base forms and noun phrases that collocate with the item in the same sentence or in the preceding or following sentences, with frequencies for each collocation.

The resulting information is combined in a data structure called the Analyzed TextualDocument (14) used in all phases of the LIDA Methodology. The Analyzed TextualDocument (14) for the Document (13) extract in Table 1 is shown in Table 3. The column “Location of occurrences in text (sentences)” gives just the numbers of sentences due to lack of space; in the LIDA tool, however, the user can see these sentences arranged in a concordance display, which is a proven effective display method in linguistic processing. The concordance display of sentences for the noun word base ‘course’ in the Document (13) extract in Table 1 is shown in Table 4.

TABLE 3

| | | | Loc- | | | |
|---|---|---|---|---|---|---|
| | | Num- | ation of | | | |
| | | ber of | occurr- | | | |
| | | occurr- | ence | | | Collo- |
| | Part-of- | ences | in text | Collo- | Collo- | cated |
| Base | speech | in this | (sent- | cated | cated | adjec- |
| form | (POS) | POS | ences) | nouns | verbs | tives |
| course | noun | 5 | 5, 6, 7, 8 | number | teach, | |
| | | | | | take | |
| professor | noun | 4 | 3, 5, 7, 8 | | teach | |
| employee | noun | 3 | 1, 2, 3 | | | |
| student | noun | 3 | 1, 5, 8 | | take | |
| teach | verb | 3 | 5, 7, 8 | pro- | | |
| | | | | fessor | | |
| take | verb | 2 | 5, 8 | student, | | |
| | | | | course | | |
| number | noun | 2 | 2, 6 | ID, | | |
| | | | | course | | |
| ID | noun | 2 | 2 | number | | |
| name | noun | 1 | 6 | | | |
| enrollment | noun | 1 | 6 | | | max- |
| | | | | | | imum |
| salary | noun | 1 | 2 | | | |
| base | noun | 1 | 2 | salary, | | |
| | | | | em- | | |
| | | | | ployee | | |
| | noun | 1 | 1 | | | |
| type | noun | 1 | 1 | | | |
| people | noun | 1 | 1 | | | |
| tenure | noun | 1 | 4 | status | | |
| status | noun | 1 | 4 | tenure, | | |
| | | | | pro- | | |
| | | | | fessor | | |
| group | noun | 1 | 3 | em- | | major |
| | | | | ployee | | |
| maximum | adjective | 1 | 6 | en- | | |
| | | | | rollment | | |
| major | adjective | 1 | 3 | group | | |

TABLE 4

| | | |
|---|---|---|
| Professors teach | courses | which students take |
| | Courses | have a number and a name and a maximum |
| | | enrollment |
| Each | course | is taught by one professor, sometimes two |
| Students must take at least one | course | and each professor teaches exactly one |
| | | course |
| each professor teaches exactly one | course | |

2. Text Analysis Environment.

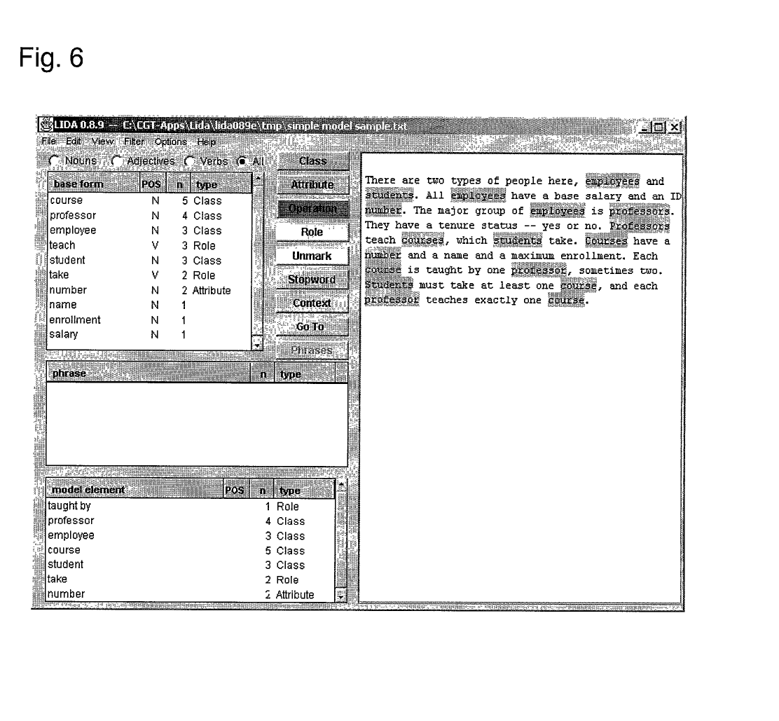

The Text Analysis Environment (5) is an interface component for the identification of candidate model elements. A sample screen shot of the Text Analysis Environment (5) is shown as FIG. 6. The main features of the Text Analyzing Environment (5) include:

Display of the text of the current Document (13);

Display of selected information from the Analyzed TextualDocument (14);

Capability for the user to identify candidate model elements by highlighting the corresponding words, word base forms and noun phrases in different colors, each color corresponding to a particular model element type.

Display of words, word base forms and noun phrases in the text using distinct colors depending on the element types (class, attribute, role, etc.) that they denote in the associated model.

The Text Analysis Environment component (5) is tightly integrated with the Model Description Environment (6) described below so that any change in the identification of model elements directly propagates to the Model Description Environment (6).

3. Model Description Environment.

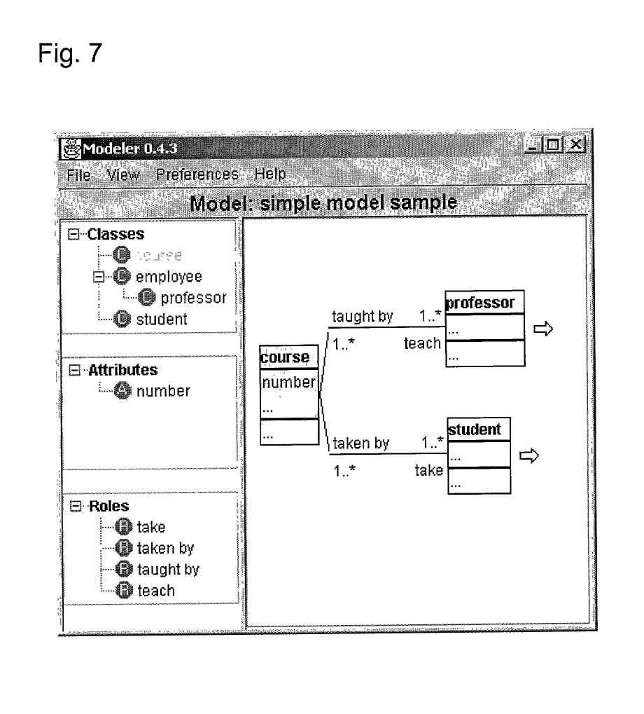

The Model Description Environment (6), illustrated in FIG. 7, is an interface for building a model from the candidate model elements. The main functions of the Model Description Environment component (6) include:

Displaying lists (vocabularies) of candidate model elements, either identified in the Text Analyzing Environment (5) or added directly in the Model Description Environment (6). In FIG. 7, the candidate model elements are displayed on the left side of the window. Any changes to the candidate vocabularies propagate to the Text Analysis Environment (5). This bidirectional propagation of information between the Text Analysis Environment (5) and the Model Description Environment (6) enables a developer to go back and forth between the text analysis process and the model building process. The resulting interleaving of these processes is a crucial part of the LIDA methodology

Offering operations for combining model elements into a class diagram corresponding to the object model (16).

Displaying textual contexts such as the one illustrated in Table 4, which are used in the process of model building and validation

Displaying textual paraphrases of model elements produced by the Model Paraphrase Component (9), which are used to validate or document the model.

Displaying warnings produced by the Document-Model Comparison Component (8), which are used to validate the model (16).

4. Document-Model Comparison Component.

The input to the Document-Model Comparison Component (8) consists of the following information:

(i) an Analyzed TextualDocument (14) produced by the Document Analysis component (7) for a given Document (13);

(ii) the current model (16) in the Model Description Environment (6).

The Document-Model Comparison component (15) produces a list of warning messages resulting from the comparison of these inputs.

In particular, warning messages are produced in the following cases:

Absent model element with high word base form frequency: a warning is generated when there is a noun, adjective or verb base form, or a noun group with high frequency in the document (13) that is not found among the labels of the model elements. This can indicate either that a model element needs to be added to the model or that an existing model element is labeled with a conceptual synonym of a word or phrase used in the document (13). The component records conceptual synonyms (including acronyms) of document terms which the user identifies among the model element labels. Upon subsequent use of the component any usage of user-provided synonyms is flagged by the component without producing a warning message.

Existing model element with low word base form frequency; a warning is generated when there is a label in the model for which a corresponding noun, adjective or verb base form, or a noun group, either does not appear or has very low frequency in a large document (13). This can indicate that an element with this label either is not relevant for a given document (13) or that a conceptual synonym was used for the label (see above).

Unassociated model elements with collocated word base forms; a warning is generated when there are model elements corresponding to word base forms or noun phrases that often collocate in the documents (13) but that are not associated in the model. This can indicate a missing association between two classes or between a class and an attribute.

5. Model Paraphrase Component.

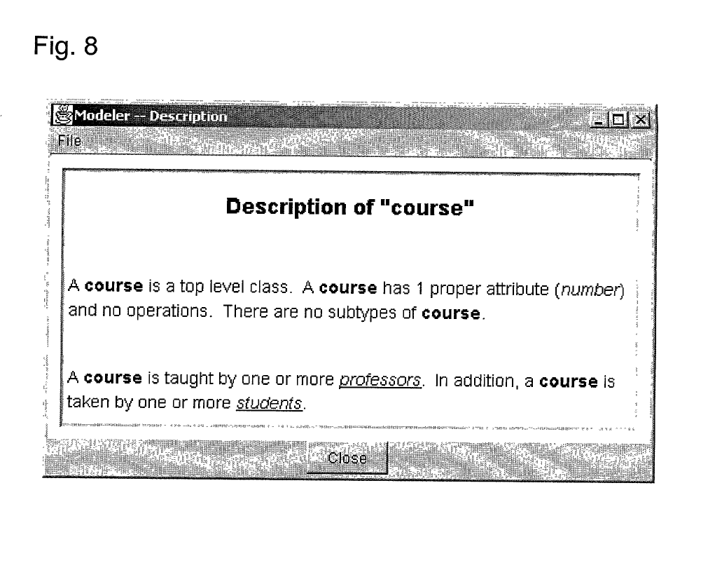

As the Model Paraphrase Component (9), LIDA integrates ModelExplainer (Lavoie et al., 1996), a tool that automatically generates fluent English hypertext descriptions for UML object models. The screen in FIG. 8 illustrates a description of the classes student and course based on the model shown in FIG. 7. The descriptions are generated from customizable text plans (Lavoie et al., 1997) set in the above example to include the following class information: super-classes, class attributes, subclasses, and associations with other classes. Hyperlinks generated with the descriptions allow the user to obtain additional descriptions and browse the model in text.

The generated descriptions can be used for different purposes, including:

Providing textual support to a LIDA user during validation of the model with domain experts who may not be familiar with the UML graphical notation used in modeling.

Allowing a user to compare the generated text with the original document for validation.

Providing textual support for a LIDA user in documenting a model.

### II. The LIDA Methodology

1. The Model Element Identification Phase

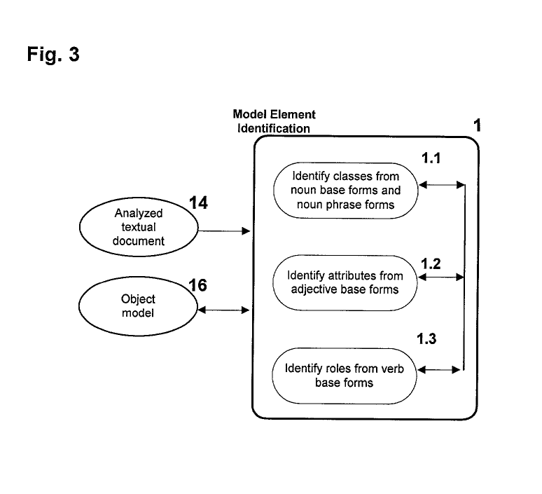

FIG. 3 shows a flowchart with a decomposition of the Model Element Identification phase (1).

The Model Identification phase (1) is performed in the Text Analysis Environment (5) using linguistic information in the Analyzed TextualDocument (14). Using functionality provided in the Text Analysis Environment ((5); section 1.2), the user identifies basic model element candidates (e.g., UML classes, attributes and roles in associations). The identified elements are automatically recorded by the Model Description Environment (6).

As a result of the Model Element Identification phase (1), the user produces a model vocabulary: a list of classes, attributes and roles. The model vocabulary is automatically stored in the Model Description Environment (6) and displayed via its graphical interface.

During the Model Element Identification phase (1) the user follows a set of guidelines which involve three main steps, that can be performed in any order:

(i) identification of the candidates for model element classes (1.1);

(ii) identification of the candidates for model element attributes (1.2);

(iii) identification of the candidates for model element roles (1.3).

In step (1.1) the user considers and possibly declares as class candidates the most frequent noun base forms or noun phrases in the Analyzed TextualDocument. For example, in the Analyzed TextualDocument in Table 3, the noun base forms ‘course’, ‘professor’, ‘employee’ and ‘student’ have the highest number of occurrences (5, 4, 3 and 3 respectively) and can be declared as candidate classes course, professor, employee, and student.

In step (1.2) the user considers and possibly declares as attribute candidates the most frequent noun or adjective base forms that collocate with noun base forms or noun phrases already identified as candidate classes. For instance, the noun base form ‘number’ from the Analyzed TextualDocument in Table 3 can be declared an attribute candidate number because it frequently collocates with ‘course’, which has been already declared a class candidate.

In step (1.3) the user considers and possibly declares as role candidates the most frequent verbs in the table of occurrences. For instance, the verb base forms ‘teach’ and ‘take’ in the Analyzed TextualDocument in Table 3 have the highest number of occurrences (3 and 2 respectively) and can be declared as roles teach and take.

A model vocabulary defined on the basis of the Analyzed TextualDocument (14) illustrated in Table 3 is shown in Table 5. Attributes are assigned to classes and associations are declared between classes during the Model Element Association phase (2), which is described next. According to the LIDA Methodology, these two phases can be interleaved at the user's convenience. In particular, the user can declare a class and an attribute, then immediately proceed to the Model Element Association phase (2) and associate these elements, then return to the Model Element Identification phase (1) and declare more elements, and so on. Such interleaving is fully supported by the Model Description Environment (6) of the LIDA tool.

TABLE 5

| | Type of | | |
|---|---|---|---|
| | model | | |
| | element | | |
| | (class, | | |
| Model | attribute | Class | Class |
| element | or role | attributes | associations |
| course | class | | |
| professor | class | | |
| employee | class | | |
| student | class | | |
| number | attribute | | |
| teach | role | | |
| take | role | | |

2. Model Element Association Phase

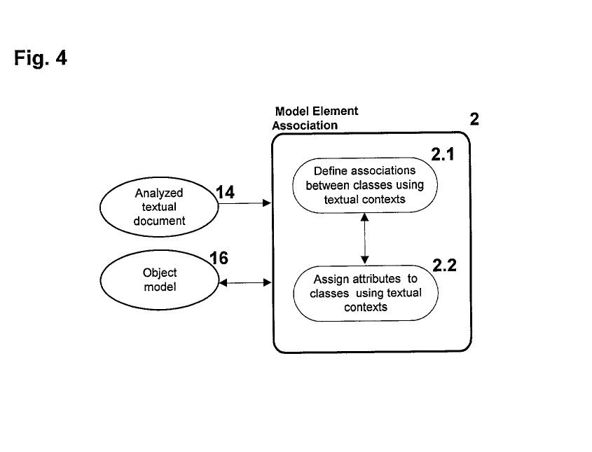

FIG. 4 shows a flowchart of the Model Element Association phase (2).

The input of the Model Element Association phase (2) consists of the following information:

(i) an Analyzed TextualDocument (14) produced by the Document Analysis (7) component for a given document (13);

(ii) a model vocabulary resulting from the Model Element Identification phase (1), and/or an existing model which needs to be developed further.

As a result of the Model Element Association phase (2) the user produces or develops a model in a language such as UML, assigning attributes to classes and defining associations between classes and their roles in these associations on the basis of information from the Analyzed TextualDocument. The work is performed via the graphical interface of the Model Description Environment (6), and the resulting model is stored and graphically displayed there.

During the Model Element Association phase (2) the user follows a set of guidelines, which consist of two main steps that can be performed in any order:

(i) identification of class associations (2.1);

(ii) identification of associations between a class and its attributes (2.2).

Step (2.1) includes the following guidelines.

For each noun base form or a noun phrase N declared as a class candidate in the model vocabulary, identify all verb base forms Vi declared as role candidates and noun base forms or noun phrases Ni declared as class candidates where the verb base form Vi collocates with N (as indicated by the Analyzed TextualDocument (14)) and where Ni collocates with Vi and occurs in the same sentence as N (as indicated by the Analyzed TextualDocument). This activity should produce a list of triples (N, Vi, Ni) indicating possible class associations.

For example, for a class candidate course the Analyzed TextualDocument (14) indicates that the corresponding noun word base ‘course’ collocates with two verb base forms ‘teach’ and ‘take’ that were declared as roles teach and take and that these two verb base forms collocate with the noun base forms ‘professor’ and ‘student’, respectively. Professor and student were also declared as class candidates. This information suggests two possible associations. The first is course (one or more)—professor (one or more) with a role teach for professor, and a role taught by for course. The second is course (one or more)—student (one or more) with a role taken by for course and a role take for student. The cardinality (1:*, 0:*, *:*, . . . ) of the association is established by analyzing the determiners and modifiers (the, any, many, one or more, etc.) used with the nouns corresponding to classes in the document, as well as by observing whether these nouns are used in singular or plural. The user can conveniently get this information at a glance in the sentence concordance display for a class.

Step (2.2) includes the following guidelines.

For each noun base form or a noun phrase N declared as a class candidate in the model vocabulary, identify all noun or adjective base forms Ai declared as attribute candidates that collocate with N, as indicated by the Analyzed TextualDocument (14). As a result of this activity, a list of tuples (N, Ai) is produced establishing possible attribute association with classes. For example, for a class candidate course the Analyzed TextualDocument indicates that the corresponding noun base form ‘course’ collocates with the noun base form ‘number’. This corresponds to a possible association between an attribute and a class: number is an attribute for course.

A UML model produced on the basis of the Analyzed TextualDocument (14) in Table 2 is shown below in Table 6.

TABLE 6

| | Type of | | |
|---|---|---|---|
| | model | | |
| | element | | |
| Model | (class, | | |
| element | attribute | Class | Class |
| stem | or role) | attributes | associations |
| course | class | number | (course, teach/taught by, 1:*, |
| | | | professor) |
| | | | (course, take/taken by, 1:*, |
| | | | student) |
| professor | class | | (professor, teach/teaches, 1:*, |
| | | | course) |
| | | | (professor, is-a, employee) |
| employee | class | | (employee, has-subclass, |
| | | | professor) |
| student | class | | (student, take/takes, 1:*, |
| | | | course) |
| number | attribute | | |
| teach | role | | |
| take | role | | |

This UML model is displayed graphically in the Model Description Environment (6) according to the standard UML notation. The graphical representation of the model in Table 6 is partially illustrated in FIG. 7. As indicated above, the LIDA Methodology is not limited to modeling in UML, but is illustrated here using the UML terminology of the implemented LIDA tool.

3. Model Validation Phase

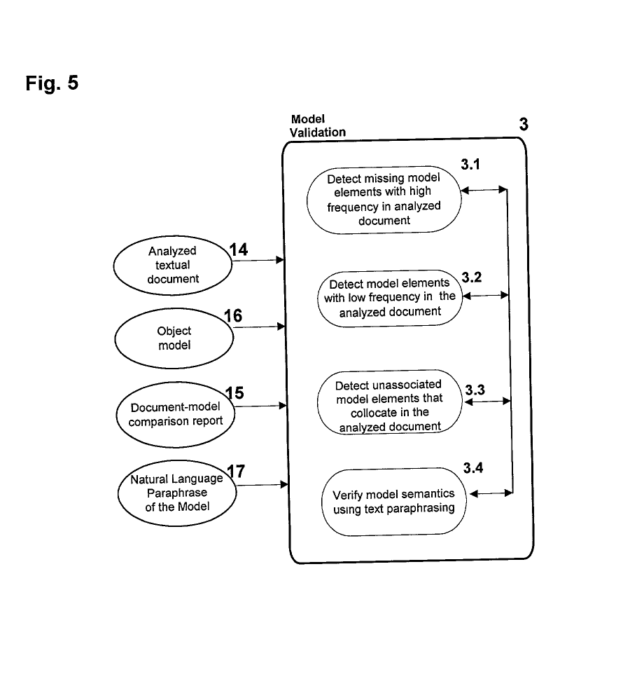

FIG. 5 shows a flowchart of the Model Validation phase (3).

During the Model Validation phase (3) the user concentrates on validating a particular model against a particular document, using the Document-Model Comparison component (8), as well as the Model Paraphrase component (9).

At the user's request, the Document-Model Comparison component (8) performs the comparison between the model (16) and the document represented in the Analyzed TextualDocument (14). If warning messages are produced, the user analyzes them and decides whether to take corrective action.

In particular, if the warning Absent model element with high word base form frequency is produced, the user can either add a missing model element to the model, or re-label some element, or record a note that a meaningful synonym was used (leading to the discrepancy between the document and model vocabularies). If the warning Existing model element with low word base form frequency is produced, the user can either delete a potentially irrelevant element from the model, or, as above, record a note that a meaningful synonym was used. Finally, if a warning Unassociated model elements with collocated word baseforms is produced, the user can add to the model a missing association between two classes or between a class and an attribute.

Also at the user's request, the Model Paraphrase Component (9), integrated with a text generator such as ModelExplainer (Lavoie et al., 1996), generates fluent hypertext descriptions in a natural language such as English for the current object model (16) that can be used for the validation of the model (16). A sample description is illustrated in FIG. 8. Object models often contain semantic errors when these models are developed by people (including experienced analysts) who are not familiar with the graphical notation. Natural language paraphrases can help developers identify these semantic errors. For example, assigning the roles of an association in the incorrect order is a frequent mistake. In the model illustrated in FIG. 7, this type of error would occur if one would reverse the roles taught by and teach between the class course and the class professor, and the roles taken by and take between the class course and the class student. The textual paraphrase of the resulting model would be grammatically correct but not semantically correct: “A course teaches one or more professors. In addition, a course takes one or more students”.

### TABLE OF REFERENCES

Burg, J. F. M. and van de Riet, R. P. (1996) Analyzing Informal Requirements Specifications: A First Step towards Conceptual Modeling, In Proceedings of the 2^{nd} International Workshop on Applications of Natural Language to Information Systems, R. P. van de Riet, J. F. M. Burg, and A. J. van der Vos, (eds), Amsterdam, The Netherlands. IOS Press, 1996, pp. 15-27.

Chen, P. P-S. (1983) English Sentence Structure and Entity-Relationship Diagram, Information Sciences, Vol. 1, No. 1, Elsevier, May 1983, pp. 127-149. Hoppenbrouwers, J., van der Vos, B., and Hoppenbrouwers, S. (1996) NL Structures and Conceptual Modelling: The KISS Case. In Proceedings of the 2^{nd} International Workshop on Applications of Natural Language to Information Systems, R. P. van de Riet, J. F. M. Burg, and A. J. van der Vos, (eds), Amsterdam, The Netherlands. IOS Press, 1996, pp. 197-209.

Korelsky, T., Lavoie, B., Overmyer, S. (2000) Linguistic Assistant for Domain Analysis (LIDA), Air Force Research Laboratory Technical Report AFRL-IF-RS-TR-2000-90, June 2000.

Lavoie, B., Rambow, O. and Reiter, E. (1996) The ModelExplainer. In Demonstration Notes of the International Natural Language Generation Workshop (INLG-96), Herstmonceux Castle, Sussex, UK, 1996, pp. 9-12.

Lavoie, B., Rambow, O. and Reiter, E. (1997) Customizable Descriptions of Object-Oriented Models, Proceedings of the 5^{th} Conference on Applied Natural Language Processing, Washington, D.C., 1997, pp. 265-268.

Miller, G. A., Beckwith, R., Fellbaum, C., Gross, D. and Miller, K. J. (1990) Introduction to WordNet: an on-line lexical database. In: International Journal of Lexicography 3 (4), 1990, pp. 235-244.

What is claimed is:

1. A method of guiding a user in iteratively deriving object models from documents such as requirements documents and validating such object models against documents, comprising the following steps, which may be applied iteratively and interleaved in any order:
a) identifying model elements using parts of speech and frequencies of word base forms and noun phrases in a document;
b) establishing associations between the model elements using collocations and textual contexts of the word base forms and noun phrases corresponding to model elements in the document;
c) validating object models using collocations and frequencies of word baseforms and noun phrases in the document, as well as natural language paraphrases of the models.

2. The method of claim 1, in which step (a) comprises the steps of:
a) identifying classes using noun base forms and noun phrases frequently occurring in the document;
b) identifying attributes using adjective base forms frequently occurring in the document;
c) identifying associations between classes using verb base forms frequently occurring in the document.

3. The method of claim 1, in which the identification in step (a) is established by automatic linguistic processing of the document.

4. The method of claim 1, in which the model elements of step (a) are based on the concepts and notation of the Unified Modeling Language for representing object models.

5. The method of claim 1, in which the model elements of step (a) are based on the concepts and notation of Entity-Relationship models.

6. The method of claim 1, in which step (b) comprises the steps of:
a) declaring associations between classes using collocations and textual contexts of word base forms corresponding to the model elements in the document;
b) associating attributes with classes using collocations and textual contexts of the word base forms corresponding to the model elements in the document;

7. The method of claim 1, in which the collocations and textual contexts are established by automatic linguistic processing.

8. The method of claim 1, in which associations between the model elements of step (b) are based on the concepts and notation of the Unified Modeling Language for representing object models.

9. The method of claim 1, in which the model elements of step (b) and associations between the elements are based on the concepts and notation of Entity-Relationship models.

10. The method of claim 1, in which step (c) comprises the steps of:
a) detecting any missing model elements having corresponding word base forms and noun phrases that occur with high frequency in the document;
b) detecting any model elements with corresponding word base forms and noun phrases that occur with low or zero frequency in the document;
c) detecting any missing associations between classes or between classes and their attributes corresponding to word base forms or noun phrase forms that collocate in the document;
d) verifying the semantics of the model using descriptive paraphrases in natural language.

11. The method of claim 1, in which the natural language paraphrases in step (c) are automatically produced.
